(19) United States
(12) Patent Application Publication
(10) Pub. No.: US 2011/0212280 A1
(43) Pub. Date: Sep. 1, 2011

(54) Expandable Pocket Design

(76) Inventor: Adam David Rapp, N. Woodmere, NY (US)

(21) Appl. No.: 12/931,334

(22) Filed: Nov. 28, 2009

(51) Int. Cl. B32B 1/00

(52) U.S. Cl. 428/34.1

(57) ABSTRACT

Expandable Pocket Design offers wearer the option to limit or decrease volume of storage capacity contain within pocket, profile of pocket and/or dimensions of mouth opening of a pocket. The design utilizes snap/Velcro or other closures at various expansion points along side fabric rectangle(s)/triangle(s)/rhombus(es) or other shape that form the left, right and/or bottom sides of pockets in any combination there of—enabling expansion properties of pocket. Closure(s) when affixed decrease the volume of area contained within pocket. The closure(s) also serve to diminishes profile or appearance of pocket. Expandable Pocket Design allows the user to define volume by altering shape and appearance by altering profile of pocket. When closures are employed along upper edge of left and/or right side fabric rectangle(s), triangle(s) and/or rhombus(es) or shape, the area composing the mouth of pocket may be altered using closures.

### TECHNICAL FIELD

Design allows optional expandability of pockets. Closures employed at various expansion points along the side fabric rectangle(s)/triangle(s)/rhombus(es) or other shape enable wearer to increase the volume of pocket.

### SUMMARY OF INVENTION

Pockets supply a volume of space wherein objects are stored for later removal. Depending on the size of object or objects stored, required volume of space withing pocket will vary. Side expanding pockets exist in numerous incarnations. They allow growth of pocket volume relative to size of object or objects being store for later removal up to a maximum achieved when all closures are in the open or unaffixed position. Users now can choose desired look and volume of their pocket.

Expandable Pocket Design employs the use of closures along side side fabric rectangle(s)/triangle(s)/rhombus(es) and/or on Central Pocket Fabric and Garment Fabric allowing the user to alter the maximum volume of space within and shape of pocket depending on preference. With the closure(s) affixed or in the closed position with male and female pieces connected, less volume will be available and a decreased pocket profile will result. As closure or closures are unaffixed, or opened, volume of pocket will increase as will the profile of pocket.

Volume and profile of pocket will depend on size, number and configuration of side fabric rectangle(s)/triangle(s)/rhombus(es), size and shape of Central Pocket Fabric, as well as variety, placement and number of closures employed.

### BRIEF DESCRIPTION OF FIGURES

FIG. 1—A selection of potential shapes the side fabric rectangle(s)/triangle(s)/rhombus(es) and Central Pocket Fabric may assume

FIG. 2—shows pieces of Expandable Pocket Design before and after stitching.

FIG. 3—shows the Expandable Pocket Design in the fully expanded position

FIG. 4—shows the mouth area of Expandable Pocket Design altered due to closure.

FIG. 5—shows volume change in Expandable Pocket Design

FIG. 6—continuing from FIG. 5 shows further volume change in Expandable Pocket Design

FIG. 7—continuing from FIG. 6 shows further volume change in Expandable Pocket Design

### DETAILED DESCRIPTION OF THE INVENTION

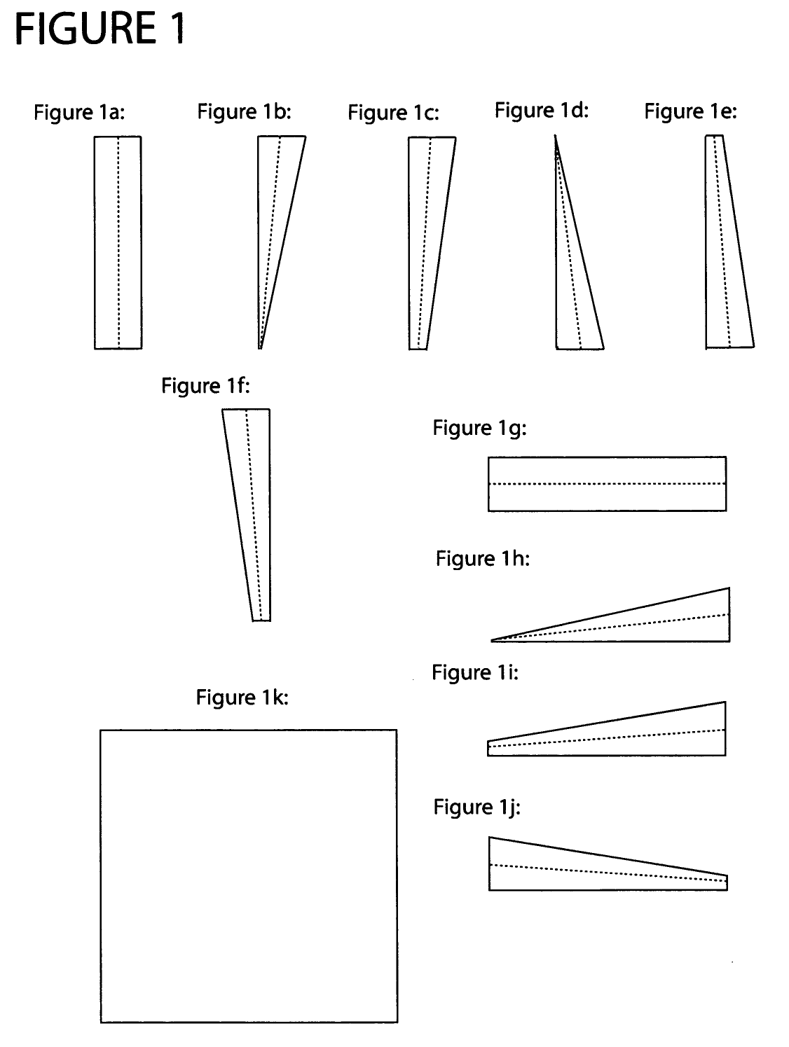

Referring to FIG. 1, Dotted lines represent theoretical midpoints of all FIGS. 1a-1j. FIGS. 1a-1e represent various potential shapes the left side fabric rectangle(s)/triangle(s)/rhombus(es) or other shape may assume and does not limit shapes they may take, merely serving to illustrate for the purpose of this description a selection of potential forms. FIG. 1a being a rectangle, FIG. 1b being a triangle with point facing down, FIG. 1c being a rhombus with smaller length facing down, FIG. 1d being a triangle with point facing upward, and FIG. 1e being a rhombus with smaller length facing upward. FIG. 1f represents a vertical reflection on FIG. 1c corresponding to a right side fabric rhombus with smaller length at bottom. FIGS. 1b, 1d and 1e can also be reflected vertically or across the Y axis to form right side equivalent shapes. FIGS. 1g-1h represent a selection of potential bottom side fabric rectangle(s)/triangle(s)/rhombus(es). FIG. 1g is a rectangle, FIG. 1h is a triangle with point facing leftward, FIG. 1i is a rhombus with smaller length facing left. FIG. 1j is a vertical reflection of FIG. 1k and represents a rhombus with smaller length facing left (FIG. 1h can also be reflected vertically) As in the case of FIGS. 1a-1f, FIGS. 1g-1j serve to illustrate for the purpose of this description potential forms bottom side fabric rectangle(s)/triangle(s)/rhombus(es) may take an are in no way limiting to the potential shapes bottom side fabric rectangle(s)/triangle(s)/rhombus(es) or other shape may assume. For the purpose of this description a rectangle Center Pocket Fabric shape will be used depicted in FIG. 1k and does not limit the potential shapes the Center Pocket Fabric may assume.

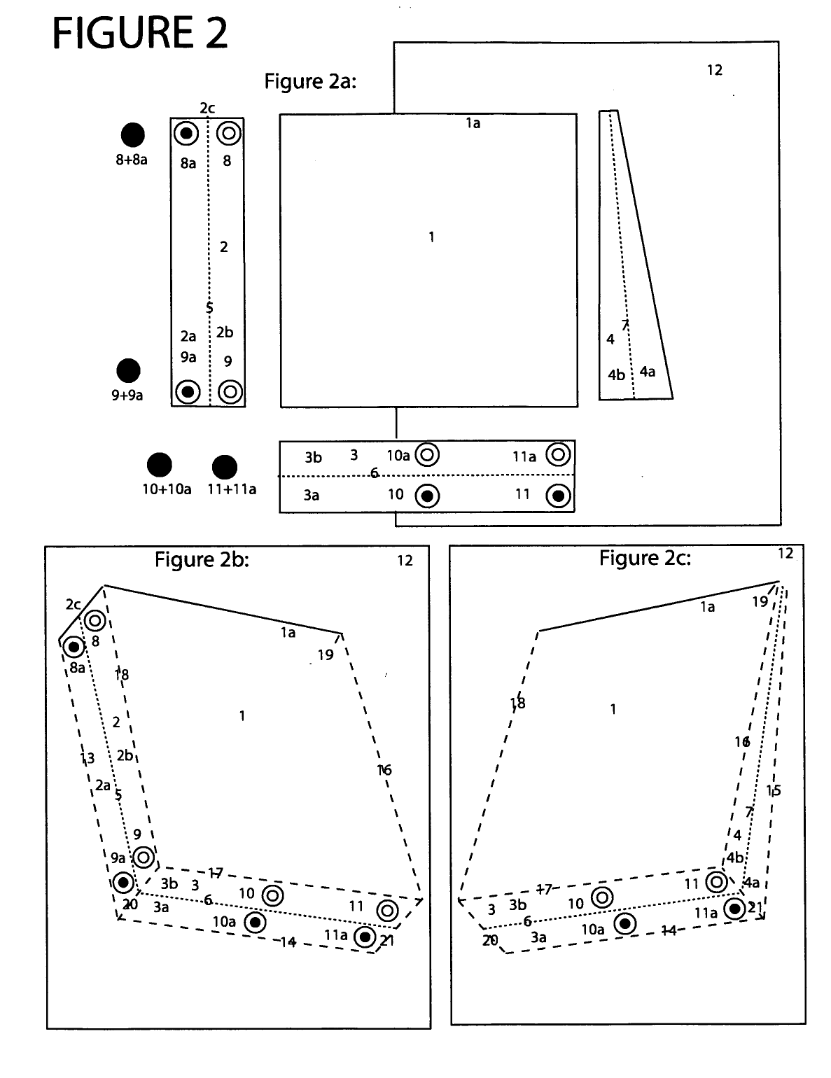

Referring to FIG. 2:

FIG. 2a show the various pieces of fabric or other material that will form the Expandable Pocket Design prior to construction or attaching via stitching or other means. These shapes show one specific form the Expandable Pocket Design may assume and is done for the purpose of this description and in no way limits the potential shapes any of the individual pieces or component involved. Design depicted in FIG. 2b shows the left and bottom perspectives of constructed Expandable Pocket Design and FIG. 2c shows the right and bottom perspective of constructed Expandable Pocket Design. Center Pocket Fabric is represented by #1 and top edge of Center Pocket fabric is #1a. Left side fabric rectangle #2 is show with theoretical midpoint line #5 where #2a and #2b corresponding halves of side fabric rectangle #2. #2c represents the top edge of left side fabric rectangle #2. A snap is used in this description where Velcro or other means may be employed. Snap #8+8a represents an example of a closed snap, while snap #8 and #8a represent the corresponding pieces that “snap” or close together to form #8+8a in later figures. #9 and #9a represent corresponding pieces of closed snap #9+9a. Bottom fabric rectangle #3 with theoretical midpoint line #6 where #3a and #3b represent corresponding halves of bottom fabric rectangle. #10 and #10a represent corresponding pieces of closed snap #10+10a. #11 and #11a represent corresponding pieces of closed snap #11+11a. #7 represents right side fabric rhombus with smaller length facing up. #7 represents theoretical midpoint line of side fabric rhombus forming corresponding halves #4a and #4b. #12 represents Garment Fabric as described and defined in claims.

Now Referring to FIGS. 2b & 2c. Center Pocket Fabric #1 is stitched to: left side fabric rectangle #2 by stitch #18, bottom side fabric rectangle #3 by stitch #17 and right side fabric rhombus #4 by stitch #16. Left side rectangle #2 is stitched to bottom side fabric rectangle #3 by stitch #20 and bottom side fabric rectangle #3 is stitched to right side fabric rhombus #4 by stitch #21. Left side fabric rectangle #2 is stitched to Garment Fabric #12 by stitch #13. Bottom side fabric rectangle is stitched to Garment fabric #12 by stitch #14. Right side rhombus #4 is stitched to Garment Fabric #12 by stitch #15. This forms a Expandable Pocket Design with 3 sides having side fabric rectangle(s), triangle(s) or rhombus(es) and with 4 points on side fabric portions having closures.

Stitch #19 secures upper right corner of Expandable Pocket Design and Top side of Center Pocket Fabric #1a and edge of left side fabric rectangle top edge #2c form two sides of the mouth of Expandable Pocket Design with Garment Fabric #12 forming the third through which objects pass to be stored in within pocket.

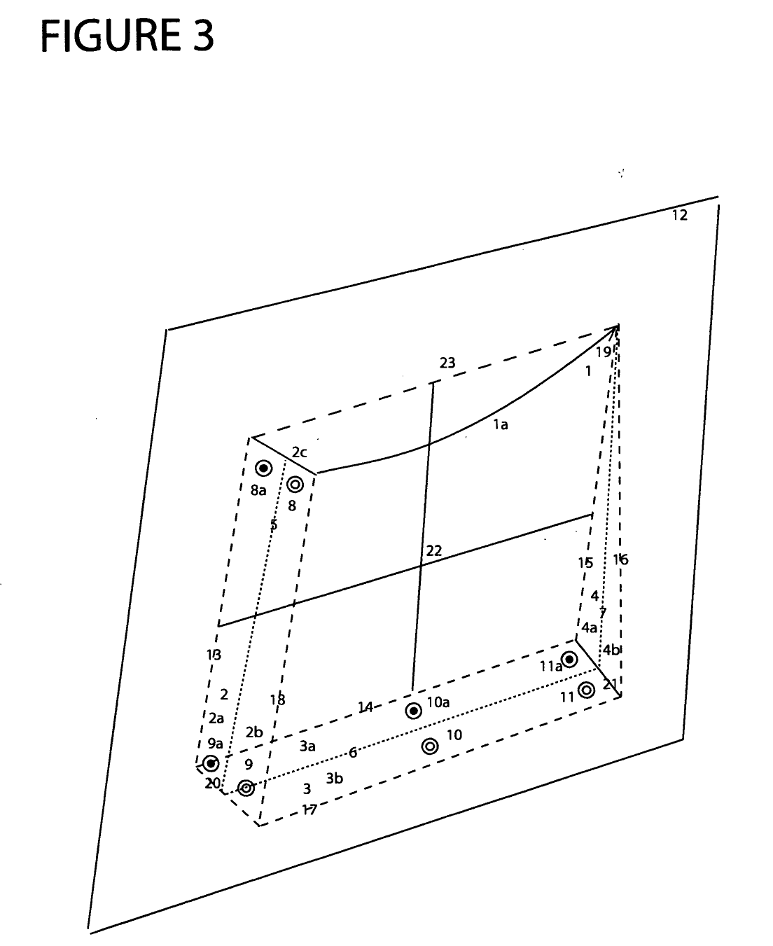

Referring to FIG. 3: (Refer to description of FIG. 2 for information on individuals numbered objects) Image of a fully expanded Expandable Pocket Design show also in FIGS. 2b and 2c. In FIG. 3 shows from top left perspective with Center Pocket Fabric being see through to layers below to show how internal pocket configuration appears. Pocket Mouth Area is shown as the area within boundaries #1a, #2c and #23 with #22 representing the internal area of pocket.

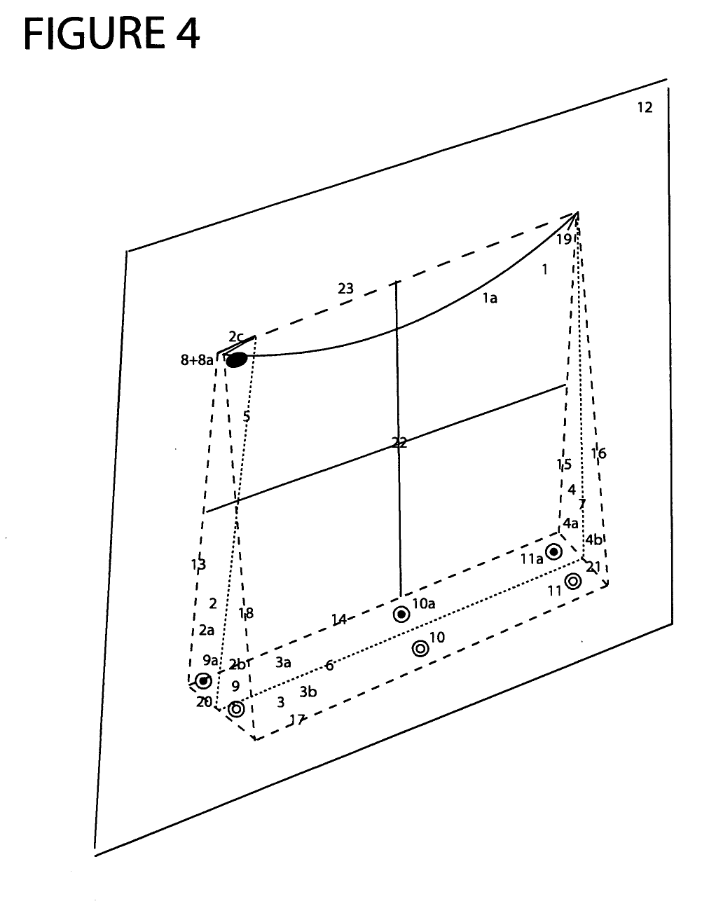

Referring to FIG. 4: (Refer to description of FIG. 2 for information on individuals numbered objects) This figure shows the Expandable Pocket Design with the left side snap piece #8 and snap piece #8a affixed in the closed position #8+8a. Pocket mouth area formed by #1a, #23 and #2c has been reduced due to snap 8+8a affixed in the closed position causing top edge of left side fabric rectangle #2c to fold and move inward. (refer back to FIG. 2) Snap piece #8a attached to left side #2a and snap piece #8 attached to right side #2b closed in #8+8a position forces midpoint of left side fabric rectangle #5 to move within pocket area formed by #22. Volume of storage area within pocket is decreased, top profile of Expandable Pocket Design is also decreased.

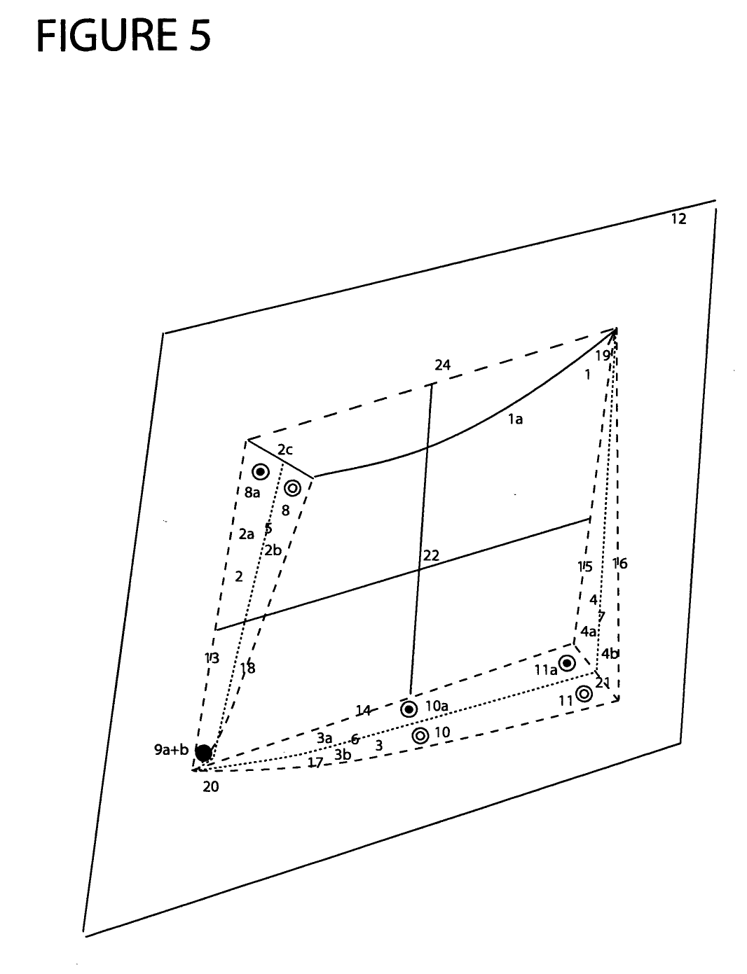

Referring to FIG. 5: (Refer to description of FIG. 2 for information on individuals numbered objects) Shows the Expandable Pocket Design with left side snap pieces #9 and snap piece #9a affixed in the closed position #9+9a. Snap piece #9a attached to left side #2a and snap piece #9 attached to right side #2b closed in #9+9a position forces midpoint of left side fabric rectangle and bottom side fabric stitch #20 to move within pocket area formed by #22. Decreasing profile of bottom left corner of pocket and volume of available storage in Expandable Pocket Design.

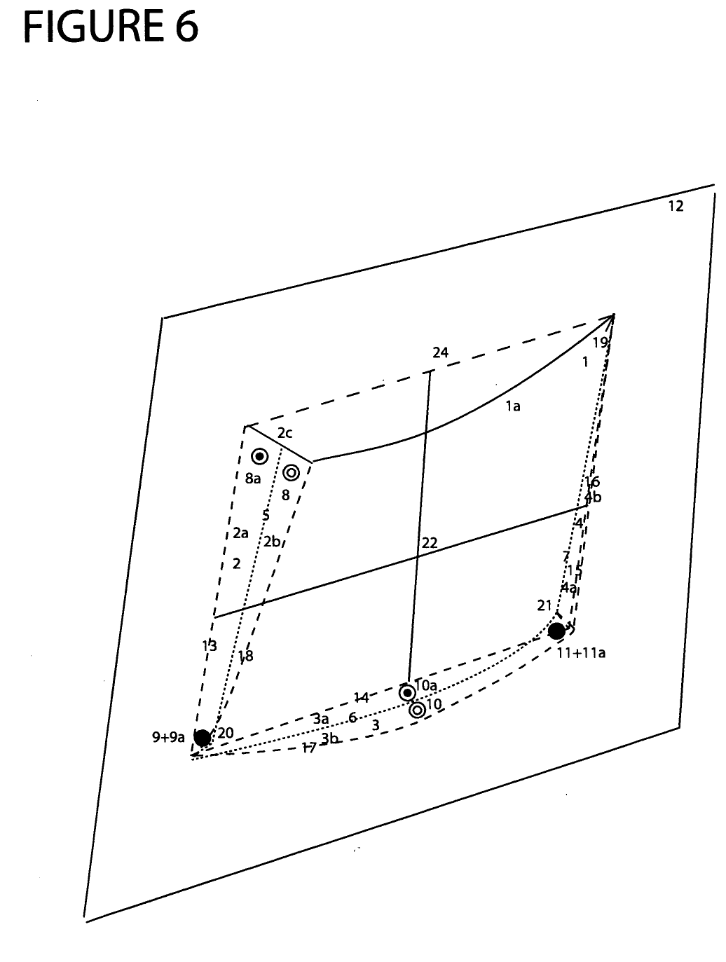

Referring to FIG. 6 (Refer to description of FIG. 2 for information on individuals numbered objects) and continuing on description of FIG. 5 above, Expandable Pocket Design volume and profile is further reduced with closure of snap #11+11a by affixing snap piece #11a attached to #3a and snap piece #11 attached to #3b. Stitch #21 joining bottom fabric #3 and right side fabric #4 along with corresponding theoretical midpoint line #7 and #6 are moved inward to a position with area formed by #22. Storage volume is further decrease as is profile of bottom right corner of pocket.

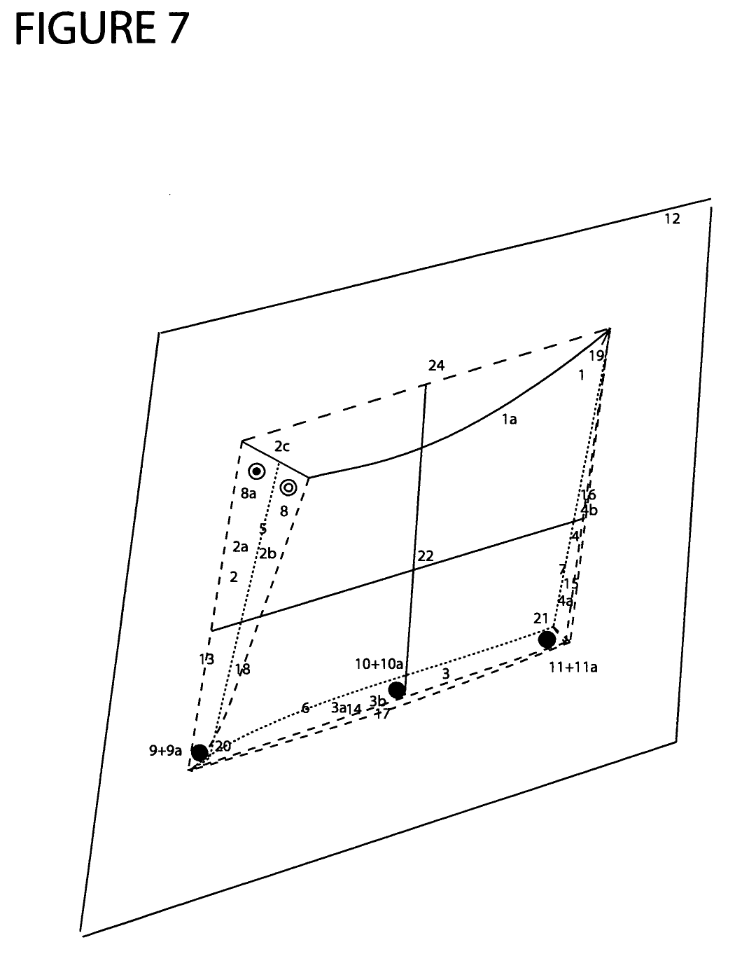

Referring to FIG. 7 (Refer to description of FIG. 2 for information on individuals numbered objects) and continuing on description of FIG. 5 above, Expandable Pocket Design volume and profile is further reduced with closure of snap #10+10a by affixing snap piece #10a attached to #3a and snap piece #10 attached to #3b. Theoretical midpoint line #5 is forced inward as bottom fabric rectangle #3 folds inward as a result of snap #10+10a. Storage volume is further decreased as is profile of Expandable Pocket Design bottom.

Having thus described the invention in detail using a specific Expandable Pocket Design configuration, it is to be appreciated and will be apparent to those skilled in the art that many physical changes could be made in the Expandable Pocket Design without altering the inventive concepts and principles embodied therein. The present embodiment is therefore to be considered in all respects as not restrictive, the scope of the invention being indicated by the appended claims and foregoing description, and all changes which come within the meaning and range of equivalency of the claims and description are therefore to be embraced therein.

Therefore I claim:

1- Any object including but not limited to pants, shorts, variations thereof, bags, variations there of, jackets, variations thereof, or any object that has or could have pockets or storage compartments. “Garment Fabric” will be defined as any fabric or other material to which Expandable Pocket Design is attached via stitching or other means such as glue, tape, etc.

2- A pocket is defined as created by fabric or other material that creates a volume of area wherein objects can be stored for later removal—composed of “Central Pocket Fabric” taking the form of a rectangle or other shape of fabric or other material forming the center section of Expandable Pocket Design with side fabric pieces attached via stitching or other means such as glue, tape, etc. to the left, right, and/or bottom sides (edges) in any combination thereof. Left, Right or Bottom most Piece of fabric forming said pocket be that a side fabric rectangle/triangle/rhombus or other shape or Central Pocket Fabric that contains the left most edge, right most edge and bottom most edge of said pocket is then stitched or affixed via other means such as glue, etc. to the Garment Fabric creating a pocket with mouth opening along top edge. If left and/or right side fabric rectangle(s)/triangle(s)/rhombus(es) or other shape exist where bottom fabric side fabric rectangle/triangle/rhombus or other shape exist—left and right edges of bottom side may be stitched to bottom edges of left and right side fabric rectangle(s)/triangle(s)/rhombus(es).

4- Snaps/Velcro or other closures can be affixed to any point along the side fabric rectangle(s)/triangle(s)/rhombus(es) or other shape. Snap and Velcro closures composed of two parts, one male and one female that affix together; one being attached to the left and the other respectively being attached to the right of a theoretical midpoint line extending vertically or diagonally the length of left and right side fabric rectangle(s)/triangle(s)/rhombus(es) or other shape and on the top and bottom of a theoretical midpoint line extending horizontally or diagonally the length of bottom side fabric rectangle/triangle/rhombus or other shape where Left, Right and Bottom side fabric exists forming Expandable Pocket Design. Closure can also be affixed to Central Pocket Fabric and corresponding closure can then be affixed to Garment Fabric.

5- Expandable Pocket Design facilitates expansion of pockets—increasing volume of interior carrying capacity of pocket. Pocket can expand outward and grow in volume of space contained within pocket as objects are stowed within for later removal up to a maximum volume achieved when all closures are in the unaffixed position. Pocket described above has a top opening. It is possible to rotate Expandable Pocket Design 90 degrees clockwise or 90 degrees counter clockwise and have pocket opening on the left or right side respectively.

6- Pocket mouth can unsealed or closure can be facilitated by fabric flap attached above top edge of central pocket fabric on Garment fabric with fabric extending over mouth of pocket affixed to a closure on front face of Central Pocket Fabric and/or a zipper with half attached to the top edge of central fabric and corresponding half attached to garment fabric, button below top edge of Central Pocket fabric with corresponding button hole in the Central Pocket Fabric, Velcro with one half attached below top edge of Central Pocket Fabric and other half to Garment Fabric. One or more technique to seal mouth of pocket in any combination can be used in each instance of Expandable Pocket Design.
